(19) United States
(12) Patent Application Publication
(10) Pub. No.: US 2026/0316255 A1
(43) Pub. Date: Oct. 15, 2026

(54) CASE BODY AND BUILT-IN BOX BODY

(71) Applicant: Zhejiang Xianfeng Industrial Co., Ltd., Jinhua (CN)

(72) Inventors: Shuangwen LV, Jinhua (CN); Shuangwu LV, Jinhua (CN)

(73) Assignee: Zhejiang Xianfeng Industrial Co., Ltd., Jinhua (CN)

(21) Appl. No.: 19/402,897

(22) Filed: Nov. 26, 2025

(30) Foreign Application Priority Data
Apr. 14, 2025 (CN) 202510464256.6

(51) Int. Cl. B25H 3/02

(52) U.S. Cl. CPC B25H 3/022

(57) ABSTRACT

A case body includes a case main body and a case cover covering a top of the case main body. A plurality of box bodies are capable of being placed in the case main body. A plurality of limit stoppers are arranged at a position in the case body corresponding to each box body. The limit stoppers are configured to limit the corresponding box body to move forward, backward, leftward and rightward within a plane. One side of the case cover corresponding to the case main body is provided with a pressing rib. When being driven by flipping of the case cover, the pressing rib is pressed on a top surface of the box body along a top contour of the corresponding box body.

### CROSS-REFERENCE TO RELATED APPLICATIONS

The application claims priority to Chinese Patent Application CN202510464256.6, filed on Apr. 14, 2025, which is incorporated herein by reference in its entirety.

### TECHNICAL FIELD

The present disclosure relates to the technical field of a case body with a box body therein, and in particular, to a case body and a built-in box body.

### BACKGROUND

The statements herein only provide the background related to the present disclosure and do not necessarily constitute the prior art.

A tool box is a container for storing and carrying tools. In order to further facilitate arranging and categorizing tools, a plurality of box bodies are placed inside the tool box, and corresponding tools and parts (such as screwdrivers, screws, nuts, and the like) are placed in corresponding box bodies.

However, most of the box bodies are just placed inside a case body, and the box bodies inside the case body are not limited. The box body is limited only by a side wall of the case body and an object in the case body. Such a limit may not have much influence when subjected to slight collision or shaking. However, in the case of severe shaking, falling of the case body, or significant jolts during transportation, the internal box bodies may be displaced, inclined, or even toppled with respect to the case body. Parts inside the box bodies may be scattered all over the case body, which requires a lot of manpower to rearrange.

### SUMMARY

In order to solve the disadvantages mentioned in the above background, the present disclosure provides a case body and a built-in box body.

In order to achieve the above objective, the technical solution of the present disclosure is achieved as follows: a case body, including a case main body and a case cover covering a top of the case main body, where a plurality of box bodies are capable of being placed in the case main body, a plurality of limit stoppers are arranged at a position in the case body corresponding to each box body, and the limit stoppers are configured to limit the corresponding box body to move forward, backward, leftward and rightward within a plane, and limit a position of each box body corresponding to the case main body in an initial state; and one side of the case cover corresponding to the case main body is provided with a pressing rib, and when being driven by flipping of the case cover, the pressing rib is pressed on a top surface of the box body along a top contour of the corresponding box body.

Further, the box bodies located in the case main body fill an internal space of the case main body.

Further, the limit stoppers are arc-shaped stoppers which are arranged at four corners of a bottom of the box body and are matched with shapes of the corners of the corresponding box body.

Further, the case body further includes a limit block arranged at a side of the case main body and located at an upper part of the corresponding box body, the limit block is located at a corner of the corresponding box body and is matched with a shape of the corner of the box body, and the limit block is configured to constrain the box body from the upper part of the box body.

Further, a retaining rib is provided at a position of a side of the case main body corresponding to each box body, and the retaining rib is configured to prevent the box body from inclining in a direction of a side wall of the case main body.

Further, one side of a bottom of the case main body is provided with a step along a lower part of the side wall, one side of the step away from the corresponding side wall is detachably provided with a cushion block, the cushion block has the same length as the step, two ends of the cushion block in a length direction are in contact with the side wall of the case main body, a top of the cushion block is flush with a top surface of the step, a plane for bearing the box body is formed, and a limit stopper is also arranged at a position of the top of the cushion block and the step corresponding to the box body; and the box body includes a first box body and a second box body, when the first box body is placed, the cushion block is separated from the case main body, the first box body is placed in the case main body perpendicular to a length direction of the step, and a clearance groove is arranged at a position of the first box body corresponding to the step; and when the second box body is placed, the cushion block is placed in the case main body, and the second box body places the cushion block and a top surface of the step along a length direction of the cushion block.

Further, a limit part is arranged at a position in the case main body corresponding to the cushion block, and the limit part is configured to limit a position of the cushion block with respect to the case main body.

Further, the limit part includes a clamping groove arranged at the bottom of the case main body, and the cushion block is engaged with the clamping groove from top to bottom.

Further, an outer side of the case main body is provided with a hook groove.

The present disclosure further provides a built-in box body, where the built-in box body is placed in the case body described above in cooperation with a first box body or a second box body, the built-in box body is divided into a mouth part, a main body part, and a foot part from top to bottom, the mouth part and the foot part are regular polygons, centers of the regular polygons of the mouth part and the foot part are coincident, a hook is arranged directly below one side of the mouth part for hooking with a hook groove, the main body part is eccentrically placed between the mouth part and the foot part, and there is clearance between the main body part and the hook for hooking so that a hooking requirement is satisfied.

Further, an internal space of the built-in box body gradually increases from bottom to top, and a bottom of one built-in box body of two built-in box bodies is capable of being inserted into the other built-in box body through the mouth part of the other built-in box body; and a plurality of vertical ribs are vertically distributed around an outer side of the built-in box body, the vertical ribs are arranged on the main body part from top to bottom, there is a gap between the vertical rib and the foot part, the part of the main body part corresponding to the vertical rib is incapable of being inserted into the other built-in box body when being blocked by the vertical rib, and the vertical rib is configured to increase the overall strength of the built-in box body and control the depth of the main body part inserted into the other built-in box body.

The present disclosure has the following beneficial effects.

According to the present disclosure, the limit stopper is arranged to define a position of the box body corresponding to the case main body while limiting the box body to move forward, backward, leftward and rightward, thereby facilitating a user to return the box body to the original position. On the one hand, the pressing rib is arranged to limit the box body in all directions in cooperation with the limit stopper. On the other hand, the pressing rib is arranged along a top contour of the corresponding box body. In this way, parts such as screws in the box body may not come out of the box body, the pressing rib is not deformed easily, and the arrangement of the pressing rib can also increase the strength of the case cover in turn.

### BRIEF DESCRIPTION OF THE DRAWINGS

FIG. 1 is an overall schematic diagram of the case body according to the present disclosure.

FIG. 2 is a diagram of the internal structure of the case body according to the present disclosure.

FIG. 3 is a schematic diagram of the structure of the step and the cushion block according to the present disclosure.

FIG. 4 is a schematic diagram of the placement of the first box body according to the present disclosure.

FIG. 5 is a schematic diagram of the structure of the built-in box body according to the present disclosure.

### DETAILED DESCRIPTION OF THE EMBODIMENTS

The present disclosure will be further described in detail with reference to the drawings and embodiments. Obviously, the described embodiments are only some embodiments of the present disclosure, rather than all of the embodiments. The embodiments in the present disclosure and the features in the embodiments can be combined with each other without conflict. Based on the embodiments in the present disclosure, all other embodiments obtained by those skilled in the art without paying creative labor belong to the scope of protection of the present disclosure.

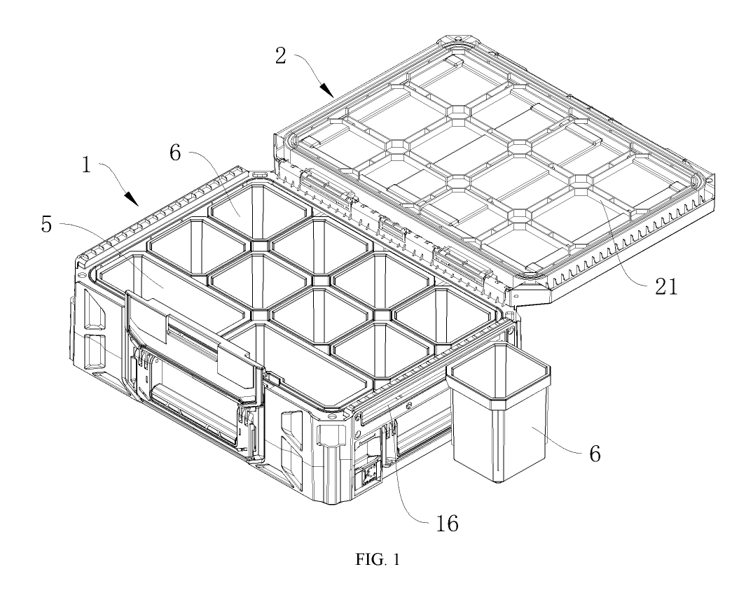

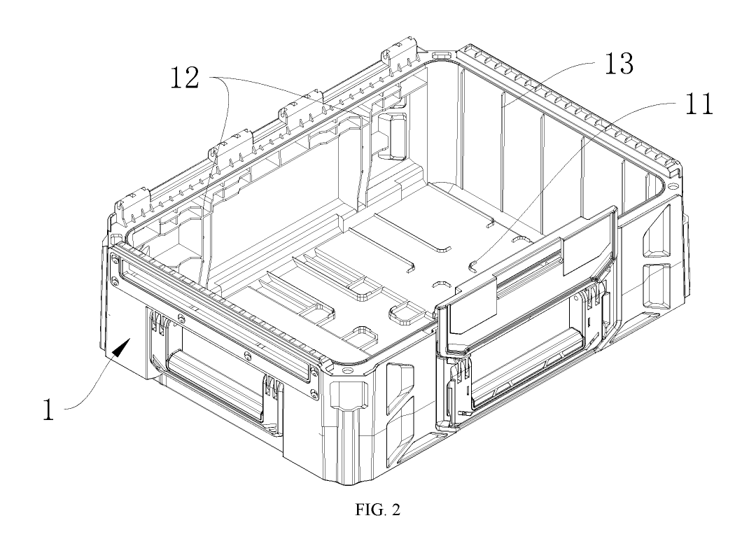

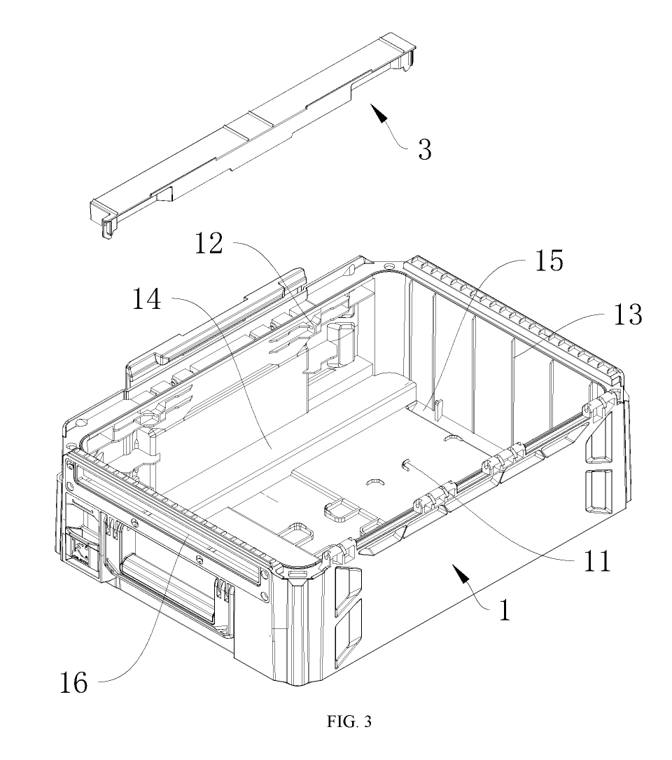

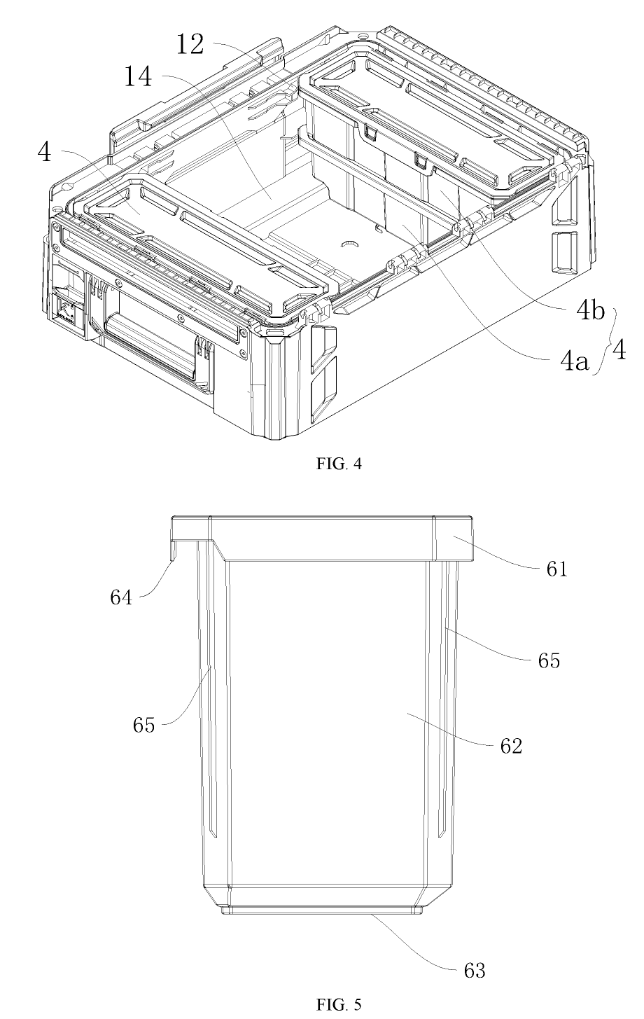

Referring to FIGS. 1-5, the present disclosure provides a case body. The case body includes a case main body 1 and a case cover 2 covering a top of the case main body 1. A plurality of box bodies are capable of being placed in the case main body 1. A plurality of limit stoppers 11 are arranged at a position in the case body corresponding to each box body. The limit stoppers 11 are configured to limit the corresponding box body to move forward, backward, leftward and rightward within a plane, and limit a position of each box body corresponding to the case main body 1 in an initial state.

One side of the case cover 2 corresponding to the case main body 1 is provided with a pressing rib 21. When being driven by flipping of the case cover 2, the pressing rib 21 is pressed on a top surface of the box body along a top contour of the corresponding box body.

In a specific implementation, the limit stopper 11 is arranged to limit the box body to move forward, backward, leftward and rightward and define a position of the box body corresponding to the case main body 1, thereby facilitating a user to return the box body to the original position. On the one hand, the pressing rib 21 is arranged to limit the box body in all directions in cooperation with the limit stopper 11. On the other hand, the pressing rib 21 is arranged along a top contour of the corresponding box body. In this way, parts such as screws in the box body may not come out of the box body (an inner wall of the case cover 2 may be deformed, and once the inner wall is deformed, a top of the box body cannot be closed, so that compared with the method of closing the top of the box body with the case cover 2, the arrangement of the pressing rib 21 can greatly avoid this situation), the pressing rib 21 is not deformed easily, and the arrangement of the pressing rib 21 can also increase the strength of the case cover 2 in turn.

In an embodiment, the box bodies located in the case main body 1 fill an internal space of the case main body 1. With this design, the box body located in the case main body 1 have no space for the box body to incline in the case main body 1 when abutted against adjacent box bodies, thereby further enhancing the stability of the box body in the case body.

In an embodiment, the limit stoppers 11 are arc-shaped stoppers which are arranged at four corners of a bottom of the box body and are matched with shapes of the corners of the corresponding box body.

In an embodiment, the case body further includes a limit block 12 arranged at a side of the case main body 1 and located at an upper part of the corresponding box body. The limit block 12 is located at a corner of the corresponding box body and is matched with a shape of the corner of the box body. The limit block 12 is configured to constrain the box body from the upper part of the box body and control the spacing between the box bodies located at a side of the case main body 1.

In a specific implementation, because the box bodies in the case main body 1 fill an internal space of the case main body 1, once the box bodies at a side of the case main body 1 are constrained, the internal box bodies can be stacked in an orderly manner and are less likely to be inclined and displaced. In addition, the limit block 12 can also limit the first box bodies 4 mentioned below which are stacked together up and down, and limit the position of the upper box bodies which are stacked together.

In an embodiment, a retaining rib 13 is provided at a position of a side of the case main body 1 corresponding to each box body, and the retaining rib 13 is configured to prevent the box body from inclining in a direction of a side wall of the case main body 1.

In a specific implementation, on the one hand, the position of the box body inside the case main body 1 is limited by the retaining rib 13 to prevent the box body from displacing (the inner wall of the case main body 1 may be deformed, so that the position of the box body cannot be well limited, and the retaining rib 13 is equivalent to a reinforcing rib, which is not deformed easily). On the other hand, because the case main body 1 has a specific draft angle during molding, a distance between a top of the case main body 1 and the box body is large, and the retaining rib 13 can reduce the gap caused by the draft angle. In addition, the arrangement of the retaining rib 13 can further increase the strength of the side wall of the case main body 1, achieving many things at one stroke.

In an embodiment, one side of a bottom of the case main body 1 is provided with a step 14 along a lower part of the side wall. One side of the step 14 away from the corresponding side wall is detachably provided with a cushion block 3. The cushion block 3 has the same length as the step 14, and two ends of the cushion block 3 in a length direction are in contact with the side wall of the case main body 1. A top of the cushion block 3 is flush with a top surface of the step 14. A plane for bearing the box body is formed. A limit stopper 11 is also arranged at a position of the top of the cushion block 3 and the step 14 corresponding to the box body.

The box body includes a first box body 4 and a second box body 5 (which do not appear in the same case main body 1 at the same time). When the first box body 4 is placed, the cushion block 3 is separated from the case main body 1, the first box body 4 is placed in the case main body 1 perpendicular to a length direction of the step 14, and a clearance groove is arranged at a position of the first box body 4 corresponding to the step 14; and when the second box body 5 is placed, the cushion block 3 is placed in the case main body 1, and the second box body 5 places the cushion block 3 and a top surface of the step 14 along a length direction of the cushion block 3. With this design, the cushion block 3 is detachably arranged, so that the case body has more space into which the first box body 4 is placed, and can provide a platform for placing the second box body 5. The structure is arranged reasonably and ingeniously.

Preferably, the first box body 4 may be a higher box body, or a box body 4a and a box body 4b which are stacked together up and down. The clearance groove is arranged at a position of a bottom of the lower box body 4a corresponding to the step 14.

In an embodiment, a limit part is arranged at a position in the case main body 1 corresponding to the cushion block 3, and the limit part is configured to limit a position of the cushion block 3 with respect to the case main body 1, thereby preventing the cushion block 3 from being displaced with respect to the case main body 1, and preventing the second box body 5 from being placed unfirmly.

The limit part includes a clamping groove 15 arranged at the bottom of the case main body 1, and the cushion block 3 is engaged with the clamping groove 15 from top to bottom.

In an embodiment, an outer side of the case main body 1 is provided with a hook groove 16 for hooking articles.

The present disclosure further provides a built-in box body. The built-in box body is placed in the case body described above in cooperation with a first box body 4 or a second box body 5. The built-in box body 6 is divided into a mouth part 61, a main body part 62, and a foot part 63 from top to bottom. The mouth part 61 and the foot part 63 are regular polygons, and centers of the regular polygons of the mouth part 61 and the foot part 63 are coincident. A hook 64 is arranged directly below one side of the mouth part 61 for hooking with a hook groove 16. The main body part 62 is eccentrically placed between the mouth part 61 and the foot part 63, and there is clearance between the main body part 62 and the hook 64 for hooking so that a hooking requirement is satisfied. With this design, the built-in box body 6 is capable of being placed in the case body no matter which side faces forward, while meeting the hooking requirement. The design is more ingenious.

Preferably, the regular polygon can be chamfered.

In an embodiment, an internal space of the built-in box body 6 gradually increases from bottom to top, and a bottom of one built-in box body 6 of two built-in box bodies 6 is capable of being inserted into the other built-in box body 6 through the mouth part 61 of the other built-in box body 6.

A plurality of vertical ribs 65 are vertically distributed around an outer side of the built-in box body 6. The vertical ribs 65 are arranged on the main body part 62 from top to bottom, and there is a gap between the vertical rib and the foot part 63. The part of the main body part 62 corresponding to the vertical rib 65 is incapable of being inserted into the other built-in box body 6 when being blocked by the vertical rib 65. The vertical rib 65 is configured to increase the overall strength of the built-in box body 6 and control the depth of the main body part 62 inserted into the other built-in box body 6.

In a specific implementation, two adjacent built-in box bodies 6 can be inserted into each other, which helps take out a plurality of built-in box bodies 6 at one time (two built-in box bodies 6 are inserted into each other up and down, and then the lower built-in box body 6 can be held with one hand, so that two built-in box bodies can be held with one hand at a time). However, the vertical rib 65 is arranged to effectively control the depth of the main body part 62 inserted into the other built-in box body 6, so as to prevent the insertion depth of the other built-in box body 6 from being too deep, which would otherwise lead to excessive friction and make it difficult to separate the two built-in box bodies.

The above is only the preferred embodiment of the present disclosure, and is not used to limit the present disclosure. Any modification, equivalent replacement, improvement, and the like made within the spirit and principle of the present disclosure should be included in the scope of protection of the present disclosure.

It should be noted that if there are directional indications (such as up and down) in the embodiment of the present disclosure, the directional indications are only used to explain the relative position relationship and movement situation between components in a specific posture (as shown in the drawing). If the specific posture changes, the directional indications may also change accordingly.

In addition, the meaning of "and/or" appearing in the present disclosure includes three parallel solutions, taking "A and/or B" as an example, including solution A, solution B, or a solution that A and B satisfy simultaneously. In addition, if there are descriptions related to "first" and "second" in the embodiment of the present disclosure, the descriptions of "first" and "second" are only used for descriptive purposes, and cannot be understood as indicating or implying the relative importance or implicitly indicating the number of indicated technical features. Therefore, the features defined as "first" and "second" can explicitly or implicitly include at least one of the features. In addition, "a plurality of" refers to more than two. In addition, the technical solutions of various embodiments can be combined with each other, but the technical solutions must be based on the feasibility for those skilled in the art to implement. When the combination of technical solutions is contradictory or impossible, it should be considered that the combination of technical solutions does not exist and is not within the scope of protection of the present disclosure.

What is claimed is:

1. A case body, comprising a case main body and a case cover covering a top of the case main body, wherein
a plurality of box bodies are capable of being placed in the case main body, a plurality of limit stoppers are arranged at a position in the case body corresponding to each box body, and the limit stoppers are configured to limit the corresponding box body to move forward, backward, leftward and rightward within a plane, and limit a position of each box body corresponding to the case main body in an initial state; and
one side of the case cover corresponding to the case main body is provided with a pressing rib, and when being driven by flipping of the case cover, the pressing rib is pressed on a top surface of the box body along a top contour of the corresponding box body.

2. The case body according to claim 1, wherein the box bodies located in the case main body fill an internal space of the case main body.

3. The case body according to claim 1, wherein the limit stoppers are arc-shaped stoppers which are arranged at four corners of a bottom of the box body and are matched with shapes of the corners of the corresponding box body.

4. The case body according to claim 1, wherein the case body further comprises a limit block arranged at a side of the case main body and located at an upper part of the corresponding box body, the limit block is located at a corner of the corresponding box body and is matched with a shape of the corner of the box body, and the limit block is configured to constrain the box body from the upper part of the box body.

5. The case body according to claim 1, wherein a retaining rib is provided at a position of a side of the case main body corresponding to each box body, and the retaining rib is configured to prevent the box body from inclining in a direction of a side wall of the case main body.

6. The case body according to claim 1, wherein one side of a bottom of the case main body is provided with a step along a lower part of the side wall, one side of the step away from the corresponding side wall is detachably provided with a cushion block, the cushion block has the same length as the step, two ends of the cushion block in a length direction are in contact with the side wall of the case main body, a top of the cushion block is flush with a top surface of the step, a plane for bearing the box body is formed, and a limit stopper is also arranged at a position of the top of the cushion block and the step corresponding to the box body; and
the box body comprises a first box body and a second box body, when the first box body is placed, the cushion block is separated from the case main body, the first box body is placed in the case main body perpendicular to a length direction of the step, and a clearance groove is arranged at a position of the first box body corresponding to the step; and when the second box body is placed, the cushion block is placed in the case main body, and the second box body places the cushion block and a top surface of the step along a length direction of the cushion block.

7. The case body according to claim 6, wherein a limit part is arranged at a position in the case main body corresponding to the cushion block, and the limit part is configured to limit a position of the cushion block with respect to the case main body.

8. The case body according to claim 7, wherein the limit part comprises a clamping groove arranged at the bottom of the case main body, and the cushion block is engaged with the clamping groove from top to bottom.

9. The case body according to claim 1, wherein an outer side of the case main body is provided with a hook groove.

10. A built-in box body, wherein the built-in box body is placed in the case body according to claim 1 in cooperation with a first box body or a second box body, the built-in box body is divided into a mouth part, a main body part, and a foot part from top to bottom, the mouth part and the foot part are regular polygons, centers of the regular polygons of the mouth part and the foot part are coincident, a hook is arranged directly below one side of the mouth part for hooking with a hook groove, the main body part is eccentrically placed between the mouth part and the foot part, and there is clearance between the main body part and the hook for hooking so that a hooking requirement is satisfied.

11. The built-in box body according to claim 10, wherein an internal space of the built-in box body gradually increases from bottom to top, and a bottom of one built-in box body of two built-in box bodies is capable of being inserted into the other built-in box body through the mouth part of the other built-in box body; and
a plurality of vertical ribs are vertically distributed around an outer side of the built-in box body, the vertical ribs are arranged on the main body part from top to bottom, there is a gap between the vertical rib and the foot part, the part of the main body part corresponding to the vertical rib is incapable of being inserted into the other built-in box body when being blocked by the vertical rib, and the vertical rib is configured to increase the overall strength of the built-in box body and control the depth of the main body part inserted into the other built-in box body.
